(19) United States
(12) Patent Application Publication
(10) Pub. No.: US 2013/0166766 A1
(43) Pub. Date: Jun. 27, 2013

(54) Streaming Service for Correlated Multi-Streaming

(71) Applicants: Klara Nahrstedt, Savoy, IL (US); Pooja Argarwal, Bellevue, WA (US); Raoul Vicente Rivas Toledano, Champaign, IL (US); Wanmin Wu, San Diego, CA (US); Md Ahsan Arefin, Champaign, IL (US); Zixia Huang, Urbana, IL (US)

(72) Inventors: Klara Nahrstedt, Savoy, IL (US); Pooja Argarwal, Bellevue, WA (US); Raoul Vicente Rivas Toledano, Champaign, IL (US); Wanmin Wu, San Diego, CA (US); Md Ahsan Arefin, Champaign, IL (US); Zixia Huang, Urbana, IL (US)

(73) Assignee: The Board of Trustees of the University of Illinois, Urbana, IL (US)

(21) Appl. No.: 13/538,589

(22) Filed: Jun. 29, 2012

Related U.S. Application Data
(60) Provisional application No. 61/503,312, filed on Jun. 30, 2011.

(51) Int. Cl. H04L 29/06

(52) U.S. Cl. CPC H04L 29/06027
USPC 709/231

(57) ABSTRACT

Multiple input devices at a source location capture data to be streamed to one or more destination locations. The captured data is provided to a streaming interface of a streaming service that encapsulates the captured data in streaming packets. The streaming interface provides the streaming packets to a streaming gateway of the streaming service that processes the streaming packets and transmits the streaming packets to a streaming gateway at the destination location. The streaming gateways manage the correlated streaming of the multiple data streams. Various processing of the data streams can be performed by the streaming gateways, including various user-defined and system-defined processing.

### RELATED APPLICATIONS

This application claims priority under 35 U.S.C. §119(e) to U.S. Provisional Patent Application No. 61/503,312, filed Jun. 30, 2011, entitled “SAS Kernel: Streaming as a Service Kernel for Correlated Multi-streaming”, to Pooja Agarwal, et al., which is hereby incorporated by reference herein in its entirety.

### GOVERNMENT LICENSE

This invention was made with government support under contract numbers NeTSE 1012194, NeTTS 0964081, CSR 0834480, and CSR 0720702 awarded by the National Science Foundation. The government has certain rights in the invention.

### BACKGROUND

As computers have become more powerful and interconnected, users have increasingly been able to stream multimedia content to and/or from their computers. This streaming typically involved a single stream of audio and/or video content. Resource management systems and techniques for supporting this streaming, however, are not without their problems. One such problem is that these systems and techniques are typically designed to support single streams, which limits their capabilities and usefulness.

### SUMMARY

This Summary is provided to introduce subject matter that is further described below in the Detailed Description. Accordingly, the Summary should not be considered to describe essential features nor used to limit the scope of the claimed subject matter.

In accordance with one or more aspects, a method implemented in a streaming as a service (SAS) framework includes receiving, at a source location, requests to stream multiple data streams for correlated multi-streaming from the source location to a destination location. These multiple data streams are received from multiple different types of input devices at the source location. Based on information included in the requests, transmitting of data packets of the multiple data streams to the destination location is managed, and this managing includes processing the data of at least one of the multiple data streams by a user-defined function.

In accordance with one or more aspects, a streaming service includes an SAS interface and an SAS gateway. The SAS interface is accessible to multiple input devices and multiple output devices at a first location. The SAS interface operates to encapsulate frames of data streams received from the multiple input devices in streaming packets prior to providing the streaming packets to the SAS gateway, and to extract frames of data streams received from the SAS gateway prior to providing the frames to the multiple output devices. The SAS gateway operates to manage communicating streaming packets with one or more other SAS gateways, including managing communication of streaming packets based at least in part on quality of service metrics defined based on multiple ones of the data streams.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 illustrates an example system implementing the streaming service for correlated multi-streaming in accordance with one or more embodiments.

FIG. 2 illustrates an example SAS kernel framework in accordance with one or more embodiments.

FIG. 3 illustrates an example system implementing the streaming service for correlated multi-streaming in accordance with one or more embodiments.

FIG. 4 illustrates an example S-RTP packet structure in accordance with one or more embodiments.

FIG. 5 is a flowchart illustrating an example process for implementing the streaming service for correlated multi-streaming in accordance with one or more embodiments.

FIG. 6 is a block diagram illustrating an example computing device in which the streaming service for correlated multi-streaming can be implemented in accordance with one or more embodiments.

### DETAILED DESCRIPTION

A streaming service for correlated multi-streaming is discussed herein. Multiple input devices at one location (e.g., a source location) capture data to be streamed to one or more other locations (e.g., one or more destination locations). The captured data is provided to a streaming interface that encapsulates the captured data in streaming packets. The streaming interface provides the streaming packets to a streaming gateway that processes the streaming packets and transmits the streaming packets to a streaming gateway at the destination location. The streaming gateways manage the correlated streaming of the multiple data streams. Various processing of the data streams can be performed by the streaming gateways, including various user-defined processing.

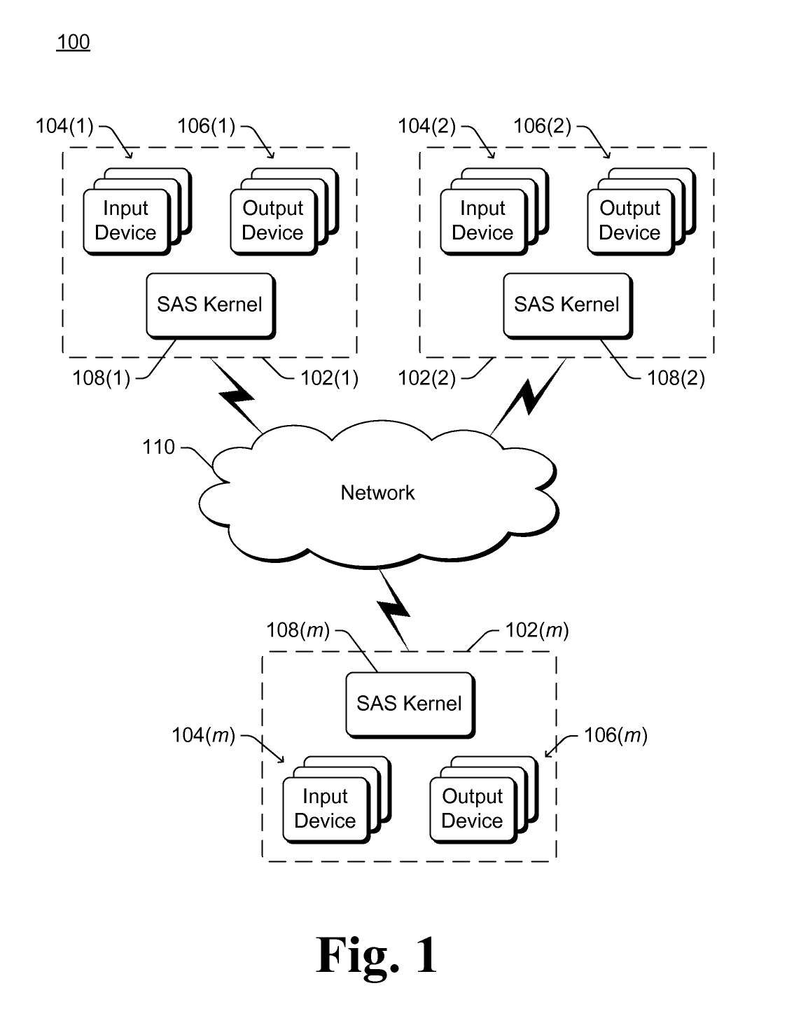

FIG. 1 illustrates an example system 100 implementing the streaming service for correlated multi-streaming in accordance with one or more embodiments. System 100 includes multiple (m) locations 102(1), . . . , 102(m), each of which includes one or more input devices 104, one or more output devices 106, and a streaming or streaming as a service (SAS) kernel 108. Correlated multi-streaming refers to multiple data streams being correlated and communicated between SAS kernels 108. Each location 102 can include any number of input devices 104 and any number of output devices 106. Different locations 102 can include the same number of input devices and/or output devices, or alternatively can include different numbers of input devices and/or output devices. Although illustrated as separate devices, it should be noted that a device can be both an input device and an output device.

Each location 102 is a different physical location, typically a different room or portion of a room. Locations 102 can be spread across any geographic distance, such as being in the same building, being in different buildings within the same city or different cities, being in different states or countries, and so forth.

Each input device 104 can be any of a variety of different types of input devices that capture (e.g., sense, detect, etc.) an aspect or characteristic of a location and/or individual at a location. Types of input devices include, for example, microphones, cameras, temperature sensors, humidity sensors, blood pressure sensors, heart rate sensors, and so forth.

Output devices 106 can be any of a variety of different types of output devices that provide feedback regarding an aspect or characteristic of another location and/or individual at another location. Types of output devices include, for example, monitors or other display devices, speakers, haptic feedback devices, and so forth.

SAS kernels 108 allow data to be streamed among the various locations 102 via network 110. Network 110 can be any one or more of a variety of different types of data communication networks, such as the Internet, a local area network (LAN), a cellular or other wireless phone network, a personal area network (PAN), and so forth. At each location 102, data obtained from input devices 104 is received by the SAS kernel 108 at that location 102, and that SAS kernel 108 manages streaming of the data to one or more other SAS kernels 108 at other locations 102. Similarly, the SAS kernel 108 at each location 102 manages receipt of data streamed from one or more other SAS kernels 108 at other locations 102 and provides the received data to output devices 106 at that location 102. Although a separate SAS kernel 108 is illustrated as being associated with each location 102, alternatively a single SAS kernel 108 can be associated with multiple locations 102. For example, a particular building may include a single SAS kernel 108 for multiple different locations (e.g., multiple different rooms in the building).

Input devices 104 and output devices 106 can provide data to and/or receive data from an SAS kernel 108 directly or via one or more other applications or devices. For example, in one or more locations 102, SAS kernel 108 may be implemented in a computing device to which multiple input devices 104 and/or output devices 106 are coupled. By way of another example, in one or more locations 102, SAS kernel 108 may be implemented in a dedicated gateway device to which multiple input devices 104 and/or output devices 106 are coupled.

It should be noted that the techniques discussed herein provide an adaptive streaming service. The SAS kernels 108 support various different applications, input devices, and/or output devices. An application and/or device need simply notify the service (e.g., be added to a session, as discussed in more detail below), and the streaming of data to and/or from the application and/or device is managed by the SAS kernels 108. The particular functions and/or operations performed by the SAS kernels 108 can also be specified by the different applications, input devices, and/or output devices, allowing different data streams to be processed in different manners.

System 100 supports a variety of different usage scenarios, oftentimes referred to as distributed interactive multimedia environments. Video, audio, and so forth of one or more users at one location is captured and streamed to another location, where the streamed video, audio, and so forth are played back. These usage scenarios include, for example, remote training scenarios, virtual world gaming scenarios, exercise scenarios, dance scenarios, fashion design scenarios, remote rehabilitation and physical therapy scenarios, cyberarcheology scenarios, sports activity scenarios, and so forth.

The data captured by each input device 104 at a particular location 102 is streamed as a sequence of frames to the SAS kernel 108 at that location 102. The SAS kernel 108 is notified (e.g., by the input devices 104) of the particular input devices that will be streaming data to the SAS kernel 108 as well as various information describing the type of data being streamed and the manner in which the data is being streamed. The data streams received from multiple input devices 104 by an SAS kernel 108 are also referred to as a bundle of streams. These streams in the bundle of streams have a spatio-temporal relationship to one another because each stream includes data captured at the same location at the same time. For example, a dancer's movements may be captured by multiple cameras at the same time the dancer's voice is captured by a microphone and at the same time the dancer's heart rate is captured by a heart rate sensor.

The SAS kernels 108 provide an open, adaptive system for streaming bundles of streams. Streams can be added to a bundle of streams and/or removed from a bundle of streams. The SAS kernel 108 is notified of the particular streams that are added and/or removed from the bundle, and adjusts its management of the streams accordingly.

Each location 102 is also referred to as a physical location or physical space. Each location 102 can be modeled as a collection of users, input devices, and output devices as follows:

PS={Uₐ,SN_{b},DI_{c}},

∀aε[0,|U|),∀bε[0,|SN|),∀cε[0,|DI|)

where PS refers to the location, |U| refers to the number of users at the location, |SN| refers to the number of input devices at the location, and |DI| refers to the number of output devices at the location.

Each input device generates data streams of captured data, and different input devices can generate data streams with different frame sizes and/or rates. The logical data unit of a data stream S is a frame generated at a time t, referred to as fₜ^{S}. Thus, a data stream S is a sequence of frames in increasing order of timestamp:

S=(f₀^{S},f₁^{S}, . . . , fₙ^{S})

where n refers to the number of frames in the data stream S.

The system 100 including the multiple locations 102 is also referred to as a joint virtual cyberspace CS. The joint virtual cyberspace CS includes the data streams being generated by the input devices 104 in the various locations 102. The various data streams can be correlated with one another in various manners, including spatial correlation, temporal correlation, and precedence correlation. A spatial correlation refers to the physical positions of input devices at the same location 102. For example, one input device may capture video of the upper body of a user, while another input device may capture video of the lower body of the user. A temporal correlation refers to the timing of data captured by different input devices. For example, the frames of data generated at a time t at the same location 102 can be can be temporally correlated with one another. A precedence correlation refers to a priority of a data stream relative to other data streams. For example, a data stream generated by one input device at a location 102 may be a higher priority than a data stream generated by another input device at that location 102.

The correlation of data streams can be determined in different manners. In one or more embodiments, the correlation is identified by the input devices that capture the data. For example, the input device can provide to the SAS kernel 108 configuration information that identifies the correlation of the data stream provided by that input device to other data streams (e.g., identifies a priority of the data stream, identifies a physical position of the input device, etc.). Alternatively, the correlation can be identified by SAS kernel 108 automatically based on the data streams (e.g., a temporal correlation can be identified based on timestamps of frames of the data streams, devices at the same location 102 can be identified as being spatially correlated, etc.).

To model a joint virtual cyberspace CS, each input device SNⱼ from each physical space PSᵢ collaborating at a given time t is mapped to a corresponding stream Sⱼ^{PS}^{ᵢ}. The joint virtual cyberspace CS and a correlation function cor( ) used to derive the correlation between all the streams belong to CS are defined as follows:

CS={Sⱼ^{PS}^{ᵢ}|∀iε[0,N_{SID}^{CS}) and ∀jε[0,|SN^{PS}^{ᵢ}|)}

cor_{CS}(Sⱼ,Sₖ)=(spatial_cor(Sⱼ,Sₖ),temporal_cor(Sⱼ,Sₖ),precedence_cor(Sⱼ,Sₖ));∀j,kε[0,|CS|)

where N_{SID}^{CS} refers to the number of locations 102 collaborating in a given session identified by a session identifier SID in CS, and |SN^{PS}^{ᵢ}| refers to the total number of input devices 104 at a location PSᵢ, spatial_cor(Sⱼ, Sₖ) refers to the spatial correlation between streams Sⱼ and Sₖ, temporal_cor(Sⱼ, Sₖ) refers to the temporal correlation between streams Sⱼ and Sₖ, and precedence_cor(Sⱼ, Sₖ) refers to the precedence correlation between streams Sⱼ and Sₖ. A particular session refers to a particular instance of data being streamed among particular locations 102 of system 100.

In one or more embodiments, a bundle of streams refers to the streams received by an SAS kernel at a particular location from multiple input devices 104 at that particular location. Alternatively, a bundle of streams may include fewer than all of the streams received by an SAS kernel at a particular location. For example, for a particular location data from multiple input devices 104 may be included as part of a strictly correlated bundle of streams or a loosely correlated bundle of streams. A strictly correlated bundle of streams refers to a collection of highly correlated data streams that are to be synchronized with one another. These highly correlated data streams have a high degree (e.g., greater than and/or equal to a threshold amount) of correlation among the spatial, temporal, and semantic correlation. A loosely correlated bundle of streams refers to a collection of loosely correlated data streams for which the desire to synchronize the streams is not as great as for a strictly correlated bundle of streams. These loosely correlated data streams can be, for example, streams having a low degree (e.g., less than and/or equal to a threshold amount) of correlation among the spatial, temporal, and semantic correlation.

In one or more embodiments, a strictly correlated bundle of streams B_{SID}^{PS} is defined as follows:

B_{SID}^{PS}={Sⱼ^{PS}|cor_{CS}(Sᵢ^{PS},Sⱼ^{PS})≧threshold_cor∀i,jε[0,|SN^{PS}|)}

where threshold_cor refers to a threshold correlation among the spatial, temporal, and semantic correlation.

Multiple bundles of streams can optionally be grouped together, which is referred to as a bundle of bundles. A bundle of bundles can be, for example, multiple bundles (e.g., a strictly correlated bundle of streams and a loosely correlated bundle of streams) streamed from one location 102 to another location 102. A bundle of bundles B_{SID}^{PS}^{₁}^{, . . . ,PS}^{ₙ} can be defined as:

B_{SID}^{PS}^{₁}^{, . . . ,PS}^{ₙ}={B_{SID}^{PS}^{ᵢ}|cor′_{CS}(B_{SID}^{PS}^{ᵢ},B_{SID}^{PS}^{ⱼ})≧threshold_cor′∀i,jε[0,n)}

where function cor′( ) refers to a correlation function used to derive the correlation between the bundles (analogous to cor( ) but for bundles of streams rather than streams), and threshold_cor′ refers to a threshold correlation among the spatial, temporal, and semantic correlation for the bundles (analogous to threshold_cor but for bundles of streams rather than streams).

Various operations can be performed for a session. For example, locations can be added to the session, locations can be removed from the session, information regarding the session (e.g., locations in the session) can be queried, and so forth. Additionally, operations related to bundles of streams can be performed for a session, such as adding a stream to a session, deleting or removing a stream from a session, editing a stream in a session (e.g., changing the correlations and/or properties of the stream such as frame rate, size, resolution, spatial correlation, temporal correlation, precedence correlation, and so forth), querying a bundle (e.g., providing criteria (e.g., correlations and/or properties of streams) and receiving in response an indication of which data streams in the session and/or bundle satisfy the criteria), and so forth.

These operations can be initiated by input devices 104 and/or output devices 106. For example, an input device 104 can initiate an operation for the data stream from that input device to be added to the session. By way of another example, an output device 106 can initiate an operation to be added as an output device to receive a data stream for the session. These operations can also be initiated by one or more applications running on a computing device. For example, a computing device at location 102 may initiate an operation to query a bundle and present to a user of the computing device an indication of which data streams in a bundle of streams satisfy the criteria.

Additionally, given a bundle of streams, a macroframe is defined which is a logical snapshot of a bundle of streams at a particular time and/or within a particular time range. The macroframe is a collection of the frames of the individual streams in the bundle of streams at that particular time and/or within that particular time range. The number of frames included in a macroframe can vary for different macroframes, depending on the relative rates of the streams and the particular time range. If a frame of a stream spans multiple macroframes, it can be included as part of all macroframes or alternatively just one macroframe (e.g., the earliest (in time) one of the multiple macroframes). The macroframe Fₜ^{B} can be defined as:

Fₜ^{B}={fₜ_{ⱼ}^{S}^{ᵢ}|∀iε[0,|B|);∀tⱼε[t,t+δ)}

where δ refers to the time range or time interval.

When streaming data over a network, various issues and/or problems with the network can result in lost data packets, delayed data packets, different packets having different travel times through the network, and so forth. These issues and/or problems can include equipment failures, data congestion, and so forth. For a particular stream, various quality of service (QoS) metrics can be defined for the single stream. In one or more embodiments, these QoS metrics include delay, jitter, skew, and loss of information, although other QoS metrics can alternatively be included.

The delay QoS metric refers to the delay incurred in transmitting the stream, and can be defined as:

De(fₜ^{S})=t_{recv}(fₜ^{S})−t_{send}(fₜ^{S})

where De(fₜ^{S}) refers to the delay on frame fₜ^{S}, fₜ^{S} refers to a frame of stream S at time t, t_{recv} refers to the time the frame is received at an SAS kernel 108 at one location 102, and t_{send} refers to the time the frame is sent from an SAS kernel 108 at another location 102.

The jitter QoS metric refers to the variation in delay between frames of the stream, and can be defined as:

Ji(fₜᵢ^{S},fₜᵢ₊₁^{S})=|De(fₜᵢ₊₁^{S})−De(fₜ^{S})|

where Ji(fₜᵢ^{S}, fₜᵢ₊₁^{S}) refers to the jitter between two frames in a stream S, fₜᵢ^{S}, refers to a frame of stream S at time ti, and fₜᵢ₊₁^{S} refers to the next consecutive frame of stream S (the frame at time ti+1).

The skew QoS metric refers to the largest difference in delay between frames of the stream, and can be defined as:

Sk(fₜ^{S}^{₀},fₜ^{S}^{₁}, . . . ,fₜ^{S}^{ₙ})=maxi_{i,j}|De(fₜ^{S}^{ᵢ})−De(fₜ^{S}^{ⱼ});

where 0≦i,j≦n,i≠j

and where Sk(fₜ^{S}^{₀}, fₜ^{S}^{₁}, . . . , fₜ^{S}^{ₙ}) refers to the skew between frames across different streams.

The loss of information QoS metric refers to the total number of frames of the data stream that are lost. Frames can be lost for various reasons, such as being corrupted or lost in transit, dropped due to congestion control mechanisms, dropped due to expiration (e.g., an expiration deadline for the frame passes), and so forth. The loss of information QoS metric can be defined as:

LoI(S)=Numf_{LN}(S)+Numf_{LE}(S)+Numf_{LD}(S)

where LoI(S) refers to the total loss of information in a stream S, Numf_{LN}(S) refers to the number of frames in the stream S lost in the network, Numf_{LE}(S) refers to the number of frames in the stream S lost due to error, and Numf_{LD}(S) refers to the number of frames in the stream S lost due to expired deadline.

In addition to QoS metrics for single streams, various QoS metrics can also be defined based on the bundles of streams. It should be noted that these bundle QoS metrics are defined based on the bundle of streams, and thus are metrics defined based on multiple data streams rather than a single data stream. In one or more embodiments, these bundle QoS metrics include bundle delay, bundle jitter, bundle skew, bundle loss of information, and bundle throughput, although other QoS metrics can alternatively be included.

The bundle delay QoS metric refers to the delay incurred in transmitting the bundle, and is the difference between the time at which the first frame of a macroframe is sent and the time at which the last frame of the macroframe is received. The bundle delay QoS metric can be defined as:

De^{B}(Fₜ^{B})=maxᵢt_{recv}(fᵢ)−minᵢ^{t}_{send}(fᵢ);

where 0≦i<|Fₜ^{B}|

and where De^{B}(Fₜ^{B}) refers to the bundle delay on macroframe Fₜ^{B}, Fₜ^{B} refers to a macroframe of bundle B at time t, maxᵢt_{recv}(fᵢ) refers to the latest time that a frame of the macroframe is received at an SAS kernel 108 at one location 102, and minᵢt_{send}(f) refers to the time the first frame of the macroframe is sent from an SAS kernel 108 at another location 102.

The bundle jitter QoS metric refers to the variation in bundle delay between two consecutive macroframes, and can be defined as:

Ji^{B}(Fₜᵢ^{B},Fₜᵢ₊₁^{B})=|De^{B}(Fₜᵢ₊₁^{B})−De^{B}(Fₜᵢ^{B})|

where Ji^{B}(Fₜᵢ^{B}, Fₜᵢ₊₁^{B}) refers to the bundle jitter between two consecutive macroframes, Fₜᵢ^{B} refers to a macroframe of bundle B at time tᵢ, and Fₜᵢ₊₁^{B} refers to the next consecutive macroframe of bundle B (the macroframe at time ti+1).

The bundle skew QoS metric refers to the largest difference in bundle delay of macroframes belonging to different bundles of data streams received from different locations 102, and can be defined as:

Sk^{B}(Fₜ^{B}^{₀},Fₜ^{B}^{₁}, . . . ,Fₜ^{B}^{ₙ})=max_{i,j}|De^{B}(Fₜ^{B}^{ᵢ})−De^{B}(Fₜ^{B}^{ⱼ})|;

where 0≦i,j≦n,i≠j

and where Sk^{B} (Fₜ^{B}^{₀}, Fₜ^{B}^{₁}, . . . , Fₜ^{B}^{ₙ}) refers to the bundle skew between macroframes across different bundles.

The bundle loss of information QoS metric refers to the total loss of information on a bundle. The bundle loss of information QoS metric can include: the intermittent lost, dropped, or delayed frames of a stream; the streams that are lost, dropped or delayed (in which case all frames in such streams are treated as being lost, dropped, or delayed); frames that depend on lost, dropped, or delayed frames (e.g., frames in the same macroframe as a lost, dropped, or delayed frame) and that are to be dropped due to incompleteness. The bundle loss of information QoS metric can be defined as:

$${LoI}^{B} ( B ) = {\sum }_{0 \leq i < \vert B \vert} {Numf}_{L N} ( {S}_{i} ) + {Numf}_{LE} ( {S}_{i} ) + {Numf}_{LD} ( {S}_{i} ) + {Numf}_{LI} ( {S}_{i} )$$

where Lol^{B}(B) refers to the bundle loss of information QoS metric for a bundle B having |B| streams, Numf_{LN}(Sᵢ) refers to the number of frames in the stream Sᵢ lost in the network, Numf_{LE}(S) refers to the number of frames in the stream Sᵢ lost due to error, Numf_{LD}(S) refers to the number of frames in the stream Sᵢ lost due to expired deadline, and Numf_{LI}(Sᵢ) refers to the number of frames in the stream Sᵢ lost due to an incomplete macroframe.

The bundle throughput QoS metric refers to, for a particular bundle, the total size of the completed macroframes received per time interval, and can be defined as:

$${Th}^{B} ( B , {t}_{p} ) = \sum \frac{size ( {F}_{i}^{B} )}{{t}_{p}} ;$$

$$where$$

$${t}_{current} - {t}_{p} \leq {t}_{recv} ( {F}_{i}^{B} ) < {t}_{current}$$

where Th^{B}(B, tₚ) refers to the throughput for bundle B over a time interval tₚ (the number of bytes received in the macroframes in the bundle B during the time interval tₚ), Fᵢ^{B} refers to the i macroframes of bundle B received during the time interval tₚ, and size(Fᵢ^{B}) refers to the size (e.g., in bytes) of the i macroframes of bundle B received during the time interval tₚ. The time interval tₚ represents an amount of time between two time instances t and t_{current}, and the number of macroframes that arrive during the time interval tₚ are identified. Any amount of time can be used for time interval tₚ (e.g., 1 second, 30 seconds, etc.), although smaller amounts of time (e.g., 1 second) can result in more precise throughput estimations for the bundle than larger amounts of time (e.g., seconds). The value t_{recv}(Fᵢ^{B}) refers to the time instance when the full macroframe Fᵢ^{B} (all the frames of the macroframe Fᵢ^{B}) arrives, which is also referred to as the receiving time instance of the macroframe Fᵢ^{B}. The t_{current}−tₚ≦t_{recv}(Fᵢ^{B})≦t_{current} qualification refers to the receiving time instances of the macroframes Fᵢ^{B} being within the time interval tₚ (being larger or equal to t_{current}−tₚ and being smaller than t_{current}), so the throughput Th^{B} (B, tₚ) reflects only macroframes that are received during the time interval tₚ.

In one or more embodiments, one or more of these bundle QoS metrics are weighted. Weighting of a bundle QoS metric refers to allowing particular aspects measured by the metric to more heavily influence the metric than other aspects. These different aspects can be, for example, particular streams, particular locations 102, and so forth.

A weighted bundle delay QoS metric can optionally be used rather than the bundle delay QoS discussed above. The weighted bundle delay QoS is generated analogous to the bundle delay QoS metric discussed above, but only takes into account frames from particular data streams. These particular data streams can be, for example, a set of priority data streams that are deemed to be of higher priority than the other streams in the bundle. Which data streams are priority data streams can be determined in different manners, such as identified by the input devices generating the data streams, identified by a user or administrator of system 100 and/or an SAS kernel 108, being pre-configured in an SAS kernel 108, and so forth. The weighted bundle delay QoS metric can be defined as:

WDe^{B}(Fₜ^{P})=maxᵢt_{recv}(fᵢ)−minᵢt_{send}(fᵢ);

where 0≦i<|Fₜ^{P}|

and where WDe^{B}(Fₜ^{P}) refers to the weighted bundle delay for the particular data streams P in the bundle B, Fₜ^{P} refers to a macroframe of the particular data streams P at time t, maxᵢt_{recv}(fᵢ) refers to the latest time that a frame of the macroframe is received at an SAS kernel 108 at one location 102, and minᵢt_{send}(fᵢ) refers to the time the first frame of the macroframe is sent from an SAS kernel 108 at another location 102.

A weighted bundle jitter QoS metric can optionally be used rather than the bundle jitter QoS metric discussed above. The weighted bundle jitter QoS metric is generated analogous to the bundle jitter QoS metric discussed above, but is determined based on variation in weighted bundle delay between two consecutive macroframes. Thus, the weighted bundle jitter QoS metric is generated as the difference between consecutive weighted bundle delays rather than consecutive bundle delays. The weighted bundle jitter QoS metric can be defined as:

WJi^{B}(Fₜᵢ^{P},Fₜᵢ₊₁^{P})=|WDe^{B}(Fₜᵢ₊₁^{P})−WDe^{B}(Fₜᵢ^{P})|

where WJi^{B}(Fₜᵢ^{P}, Fₜᵢ₊₁^{P}) refers to the weighted bundle jitter between two consecutive macroframes, Fₜᵢ^{P} refers to a macroframe of the particular data streams P at time ti, and Fₜᵢ₊₁^{P} refers to the next consecutive macroframe of the particular data streams P (the macroframe at time ti+1).

A weighted bundle skew QoS metric can optionally be used rather than the bundle skew QoS metric discussed above. The weighted bundle skew QoS metric is generated analogous to the bundle skew QoS metric discussed above, but only takes into account data streams received from particular locations. These particular locations can be, for example, a set of priority locations that are deemed to be of higher priority than the other locations in the system. Which locations are priority locations can be determined in different manners, such as identified by the input devices generating the data streams, identified by a user or administrator of system 100 and/or an SAS kernel 108, being pre-configured in an SAS kernel 108, and so forth. The weighted bundle skew QoS metric can be defined as:

WSk^{B}(Fₜ^{B}^{₀},Fₜ^{B}^{₁}, . . . ,Fₜ^{B}^{ₙ})=max_{i,j}|WDe^{B}(Fₜ^{B}^{ᵢ})−WDe^{B}(Fₜ^{B}^{ⱼ})|;

where 0≦i,j≦n,i≠j

and where WSk^{B}(Fₜ^{B}^{₀}, Fₜ^{B}^{₁}, . . . , Fₜ^{B}^{ₙ}) refers to the weighted skew between macroframes across particular sites.

These various QoS metrics, whether single stream QoS metrics, bundle QoS metrics, or weighted bundle QoS metrics, can be used by SAS kernel 108 in various manners. The various QoS metrics can be measured over time and reports generated or records maintained of these measured QoS metrics. Alternatively, various actions can be taken by SAS kernel 108 based on one or more of these QoS metrics. For example, a particular QoS metric can be measured and if that measured QoS metric falls below (or rises to) a threshold amount then a corrective action can be taken. E.g., if the bundle throughput falls below a threshold amount (or if the bundle skew rises above another threshold amount), then the SAS kernel 108 may take a corrective action such as dropping one or more lower priority data streams from the session.

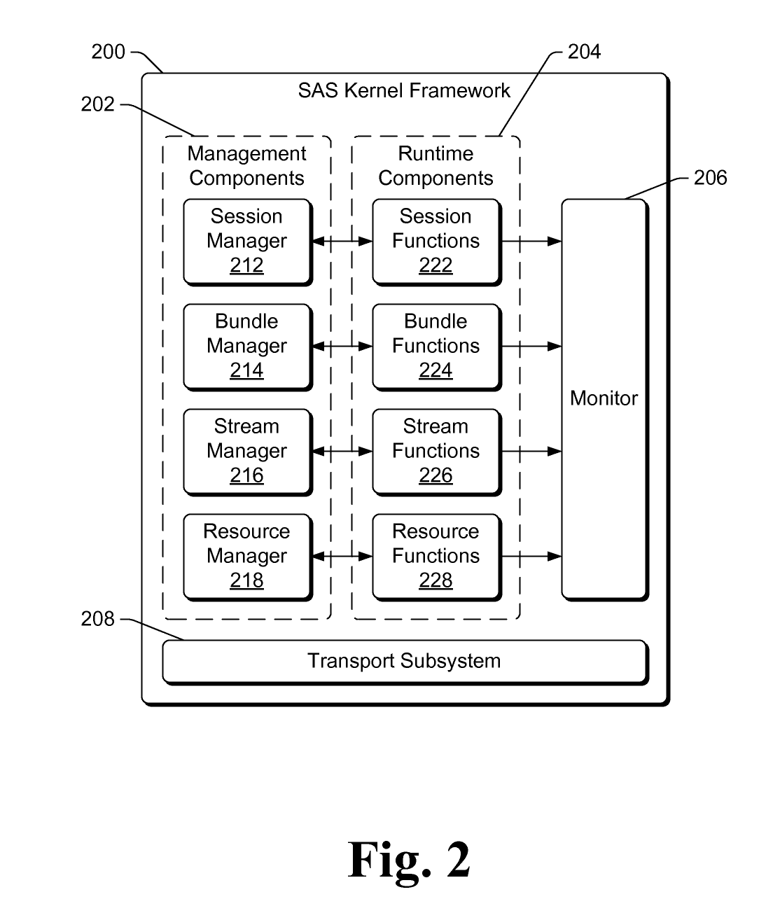

FIG. 2 illustrates an example streaming as a service (SAS) kernel framework 200 in accordance with one or more embodiments. SAS kernel framework 200 can be implemented at least in part by one or more SAS kernels 108 of FIG. 1. SAS kernel framework 200 supports one or more of various different properties, including distributed correlated multi-stream support, open access, user-defined functions, availability, robustness, and/or scalability.

The distributed correlated multi-stream support property refers to the framework 200 taking into account the spatio-temporal dependencies among the multiple streams in the bundle of streams. The framework 200 supports large scale correlated soft real-time streaming of multiple streams concurrently, and end-to-end session management based on media correlations. Framework 200 provides correlated multi-streaming by: (1) managing and keeping states of streams, bundles, sessions, and resources; and (2) providing streaming policies for correlated soft real-time scheduling, co-operative congestion control, and overlay routing. The correlated multi-streaming is managed by management components 202, as discussed in more detail below.

The open access property refers to a generic or universal access policy with defined interfaces for the input and/or output devices. Different types of input and/or output devices supporting various different standards can use the framework 200 to send and/or receive streams. The framework 200 provides a unified interface for input and/or output devices, allowing a common interface to be used by the various different input and/or output devices. This common interface, also referred to as the SAS interface, is discussed in more detail below. The framework 200 also supports easily configurable stream specifications to describe input and/or output device characteristics as well as stream characteristics.

The user-defined functions property refers to the framework providing user-defined runtime functions on streams, such as compression, encryption, view management, and so forth. These user-defined runtime function are in addition to system-defined runtime functions on streams (e.g., rate control, congestion control, multi-stream synchronization, and so forth). Thus, framework 200 is a unified framework for plugging in the various policies and functions that are implemented in a user space. Framework 200 provides runtime loading of user-defined functions operating over streams and/or bundles. These user-defined functions are provided by runtime components 204 as well as function managers of the management components 202, as discussed in more detail below.

The SAS kernel can provide various system-defined runtime functions, but it should be noted that these user-defined functions refer to functions that are defined by a device, user, and/or application other than the SAS kernel. For example, an input device and/or output device can provide a user-defined function to framework 200, or a user of an application or device can specify a user-defined function that is provided to framework 200.

The availability property refers to the framework 200 supporting an “always on” paradigm. Following an “always on” paradigm, the framework 200 provides high availability (e.g., being available greater than a threshold amount of time, such as 99% of the time), being available for use as desired by applications and/or users.

The robustness property refers to the ability of the framework 200 to monitor performance, isolate faults, automatically recover from faults, and so forth. Framework 200 provides on-demand monitoring services with varied resolution, as well as fault localization and easy recovery management. Framework 200 provides a monitor 206 that serves as a cross-layer monitoring interface and performs runtime analysis of monitoring data to trigger recovery procedures.

The scalability property refers to framework 200 being scalable to support large numbers of streams (e.g., tens, hundreds, or more streams per bundle of streams). Framework 200 is further extensible, allowing new functional services to be supported as desired. Framework 200 provides this scalability in various manners, such as via user-configurable interfaces exposed to the various input and/or output devices, the modular design of stream services to allow user-defined functions on streams, and/or a modular design of the management components 202 and runtime components 204 built on the principle of separation of concerns.

SAS kernel framework 200 includes management components 202, runtime components 204, and monitor 206, which are implemented on a transport subsystem 208.

Management components 202 manage sessions, bundles of streams, streams, frames, and their corresponding resources. Management components 202 provide mechanisms for generic tasks such as overlay routing, and provide interfaces to dynamically load runtime components 204. Management components 202 include a session manager 212, a bundle manager 214, a stream manager 216, and a resource manager 218.

Session manager 212 performs session initiation, membership control, and session management. A session refers to a particular instance of data being streamed among particular locations (e.g., locations 102 of FIG. 1). Session manager 212 takes management decisions and provides mechanisms to load session level functions such as overlay routing, admission control, and so forth.

Bundle manager 214 handles the correlation among the streams in a bundle of streams, and defines the policies to group multiple streams into correlated bundles of streams. Bundle manager 214 provides mechanisms for runtime functions over correlated bundles of streams, such as synchronization, cooperative congestion control, prioritization, view management, bundle QoS metrics, and so forth.

Stream manager 216 maintains various state information regarding receipt and delivery of streams across sites, and also determines policies for streaming. Stream manager 216 categorizes streams as incoming streams (also referred to as InStreams) from input devices, as well as outgoing streams (also referred to as OutStreams) to output devices. Stream manager 216 also provides mechanisms for stream-based runtime functions such as compression, encryption, stream QoS metrics, and so forth.

Resource manager 218 manages overlay network resources to provide real-time delivery of streams. These overlay network resources include, for example, bandwidth management, delay management, and so forth.

Runtime components 204 provide specific system and/or user-defined policies for various mechanisms. Runtime components 204 are dynamically pluggable real-time functions, including session functions 222, bundle functions 224, stream functions 226, and resource functions 228. Each of functions 222, 224, 226, and 228 are a real-time implementation of functionality of a manager 212, 214, 216, and 218, respectively. The specific functions implemented as each of functions 222, 224, 226, and 228 varies based on the user or application provided definition for a session. These functions 222, 224, 226, and 228 can include system-defined functions as well as user-defined functions.

Session functions 222 are functions operating over sessions, such as viewcasting functions, mesh functions, peer-to-peer functions, and so forth. Bundle functions 224 are functions operating over bundles of streams, such as multi-stream synchronization, bundle QoS metrics, cooperative congestion control, and so forth. Stream functions 226 are functions operating over streams, such as compression, encryption, and so forth. Resource functions 228 are functions operating over resources, such as rate control, congestion control, bandwidth allocation, and so forth.

Monitor 206 is a cross-layer event-driven monitor that provides real-time monitoring. Monitor 206 forms a feedback loop by receiving indications of the states of the functions 222-228 and communicating those states to the managers 212-218, allowing the managers 212-218 to take appropriate actions based on those states, such as adaptation, policy switching, and so forth. Monitor 206 also monitors indications received from functions 222-228 for faults and failures.

Transport subsystem 208 abstracts the underlying transport layer protocol, allowing applications as well as input and/or output devices to dynamically request appropriate protocols based the application (and/or device) type, network conditions, and so forth. Various different protocols can be supported, such as various versions of the Transmission Control Protocol (TCP), User Datagram Protocol (UDP), Datagram Congestion Control Protocol (DCCP), and so forth. In one or more embodiments, transport subsystem 208 encapsulates frames using an SAS Real-Time Protocol (S-RTP) protocol, which adds semantic information that can be used by managers 212-218, such as stream type, functions requested, device addressing, and streams in the same bundle, as discussed in more detail below.

Although particular managers and functions are illustrated in FIG. 2, it should be noted that functionality of one or more managers and/or functions can be separated into multiple managers and/or functions, and/or that functionality of one or more managers and/or functions can be combined into a single manager and/or function.

Returning to FIG. 1, in one or more embodiments, each SAS kernel is implemented as a streaming or SAS gateway and as a streaming or SAS interface. For example, each SAS kernel 108 can include both an SAS gateway and an SAS interface. The SAS interface at a location 102 provides the connectivity between the input devices 104 and/or output devices 106 at the location 102 and the SAS kernel 108 at the location 102. The SAS gateways at the various locations communicate with one another, streaming data (received from input devices via the SAS interface) to one another.

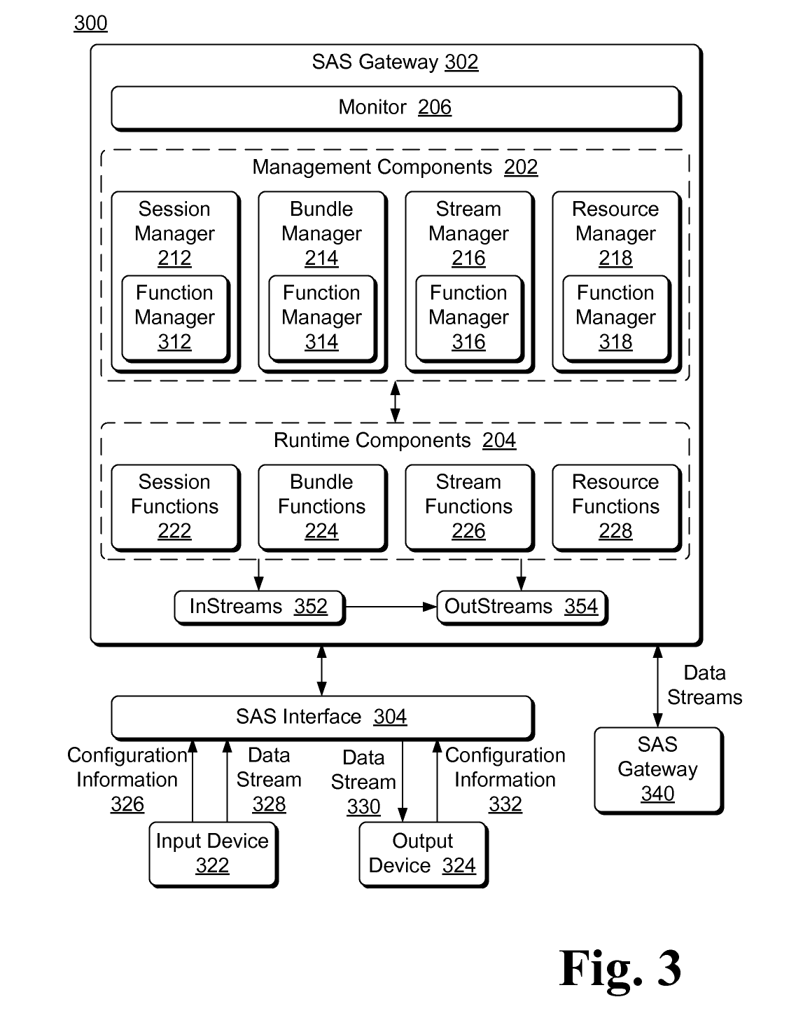

FIG. 3 illustrates an example system 300 implementing the streaming service for correlated multi-streaming in accordance with one or more embodiments. System 300 includes an SAS gateway 302 and an SAS interface 304. SAS gateway 302 includes management components 202, runtime components 204, and a monitor 206, as discussed above with reference to FIG. 2. Although particular managers and functions are illustrated in FIG. 3, it should be noted that functionality of one or more managers and/or functions can be separated into multiple managers and/or functions, and/or that functionality of one or more managers and/or functions can be combined into a single manager and/or function. SAS gateway 302 can manage, at any given time, one or more sessions with one or more other SAS gateways.

Managers 212, 214, 216, and 218 each include a function manager 312, 314, 316, and 318, respectively. Each function manager 312-318 loads and schedules functions of runtime components 204 on data (e.g., bundles, streams, frames, etc.). Function manager 312 loads and schedules zero or more of session functions 222, function manager 314 loads and schedules zero or more of bundle functions 224, function manager 316 loads and schedules zero or more of stream functions 226, and function manager 318 loads and schedules zero or more of resource functions 228. The particular functions that are loaded and scheduled (if any) can be based on input from the corresponding manager 212-218 and/or received from an input device and/or output device.

System 300 also includes an input device 322 and an output device 324. Although a single input device 322 and a single output device 324 are illustrated in system 300, it should be noted that system 300 can include multiple input devices and/or output devices, can include only one or more input devices, or can include only one or more output devices.

Input device 322 provides configuration information 326 and a data stream 328 to SAS interface 304. The data stream 328 is the frames of data captured by input device 322. The configuration information 326 identifies information describing the input device 322 and/or data stream provided by the input device 322. Various information can be provided as the configuration information 326 by input device 322, such as information identifying the type of data in the data stream (e.g., audio, video, etc.), information identifying the data subtype (e.g., for video data the data subtype could be point cloud, mesh, etc.), information identifying a location or position of the input device (e.g., an angle or point of view of data capture), information identifying the manner in which data is captured (e.g., a frame rate, size, resolution, etc.), and so forth.

Similarly, output device 324 provides configuration information 332 to, and receives a data stream 330 from, SAS interface 304. The configuration information 332 identifies information describing the output device 324 and/or the data stream 330 expected to be received by the output device 324. Various information can be provided as the configuration information 332 by output device 324, such as information identifying the type of data the output device 324 plays back (e.g., audio, video, etc.), information identifying the data subtype (e.g., for video data the data subtype could be point cloud, mesh, etc.), information identifying a location or position of the output device (e.g., an angle or point of view of playback), and so forth.

SAS interface 304 receives configuration information 326, 332, and provides the configuration information to SAS gateway 302. SAS interface 304 can provide the configuration information to SAS gateway as part of encapsulating packets of data (as discussed in more detail below), or alternatively using other data structures or data transfer mechanisms. SAS interface 304 also receives data steam 328 from input device 322 and provides the data stream 328 to SAS gateway 302, and receives a data stream from SAS gateway 302 (e.g., received by SAS gateway 302 from another SAS gateway 340). and provides that data stream to output device 324 as data stream 330. Configuration information 326, 332, as well as data streams 328, 330 can be communicated between devices 322, 324 and SAS interface 304 using any of a variety of protocols (e.g., TCP, UDP, DCCP, and so forth). Similarly, configuration information 326, 332 can be formatted using any of a variety of different data formats, such as using an Extensible Markup Language (XML) or other markup language, using other publicly available and/or proprietary formats, and so forth.

In one or more embodiments, SAS interface 304 encapsulates configuration information 326, 332, and data stream 328, in S-RTP data packets. These S-RTP data packets are also referred to as streaming packets, and provide information regarding the device 322 or 324, and/or data stream 328, to SAS gateway 302. Similarly, a data stream received by SAS interface 304 from SAS gateway 302 is encapsulated in S-RTP data packets. The data is extracted from the S-RTP data packets by SAS interface 304 before providing the data to output device 324 as data stream 330. Thus, neither input device 322 nor output device 324 need have any knowledge of the S-RTP protocol or that the S-RTP protocol is even being used.

Configuration information 326, 332 received by SAS gateway 302 is provided to session manager 212. Session manager 212 can then provide parts of the received configuration information to other managers 214-218 as appropriate.

Data in data streams of a session received from input devices (e.g., data stream 328) are maintained as incoming streams, referred to as InStreams 352, prior to being streamed from SAS gateway 302. InStreams 352 are a buffer or other data structure of frames of data for the data streams of a session. The incoming streams are typically streamed to another SAS gateway 340, but can alternatively be streamed to an output device 324. While maintained as InStreams 352, the data streams can be operated on by the various functions 222-228.

Data in data streams of a session to be provided to output device 324 are maintained as outgoing streams, referred to as OutStreams 354, prior to being streamed from SAS gateway 302. OutStreams 354 are a buffer or other data structure of frames of data for the data streams of a session. The outgoing streams are typically received from another SAS gateway 340, but can alternatively be received from an input device 322. While maintained as OutStreams 354, the data streams can be operated on by the various functions 222-228.

In one or more embodiments, SAS gateway 302 and SAS interface 304 operate as follows. For input device 322 to begin streaming data, input device 322 initiates a connection with SAS interface 304. Input device 322 is typically configured with an indication of SAS interface 304, for example due to SAS interface 304 typically being included as part of input device 322 or part of a computing device via which input device communicates with SAS gateway 302. Alternatively, input device 322 can identify which SAS interface 304 to initiate a connection with in different manners, such as by an indication received from a user of the input device, via an automatic device or service detection technique, and so forth.

SAS interface 304 then initiates a communication session with SAS gateway 302 and requests the services specified in configuration information 326. The particular SAS gateway with which SAS interface 304 initiates the communication session can be identified in different manners, such as being configured in SAS interface 304, identified by a user of the input device 322, identified using an automatic device or service detection technique, and so forth.

The received request is handled by session manager 212. Session manager 212 determines whether the requested services are supported by SAS gateway 302, and returns a response to the SAS interface 304. The response indicates acceptance or denial of the request. If the request is denied, then SAS gateway 302 does not receive and process data stream 328. An indication of a reason for the denial (e.g., an indication of one or more of the requested services that are not supported by SAS gateway 302) can optionally be returned as part of the denial.

If the request is accepted, then session manager 212 opens data and control connections with input device 322 through the SAS interface 304. If the data stream is the first data stream of a new session, then session manager 212 also instantiates an InStreams 352 data structure corresponding to the session. If the data stream is being added to an already existing session, then the previously instantiated InStreams 352 data structure is used for the data stream. Session manager 312 also constructs an overlay routing topology with other gateways (e.g., SAS gateway 340) to which the data stream received from input device 322 is to be streamed and stores metadata regarding the session. Session manager 312 can store various different metadata, such as: a number of participating sites (e.g., the number of locations 102 of FIG. 1 sending and/or receiving data streams in the session); characteristics of devices and/or media (e.g., audio and/or video device and their metadata such as frame rate, frame size, manufacturer, etc.) in each participating site (e.g., each location 102 of FIG. 1 sending and/or receiving data streams in the session); the topology of data streams (e.g., which input data stream is to be provided to what output device); device capabilities (e.g., encryption capabilities, storage capabilities, real-time support capabilities, etc.) of each participating site (e.g., each location 102 of FIG. 1 sending and/or receiving data streams in the session); and so forth. Session manager 212 also instantiates a stream manager 216 for the data stream, and adds the data stream to the appropriate bundle of streams. If a new bundle of streams is being created (e.g., the data stream is a first data stream for a bundle), then session manager 212 also instantiates a bundle manager 214 for the bundle of streams including the data stream.

In one or more embodiments, a single session is supported at any given time at each location. Thus, if an input and/or output device is added to a session, the device is added to the current session at the location of the input and/or output device. Alternatively, multiple sessions can be supported at any given time at each location. If multiple sessions are supported, then session manager 212 is provided with an indication of which session the device is being added to, and thus which bundle of streams to add the data stream to. The indication of the session can be provided in various manners, such as being included in the configuration information provided by the input and/or output device.

Input device 322 then communicates data stream 328 to SAS interface 304 as multiple frames of data. SAS interface 304 encapsulates the frames of data of data stream 328 in S-RTP data packets, which are discussed in more detail below, based at least in part on configuration information 326. The S-RTP data packets are sent from SAS interface 304 to the InStreams 352 data structure corresponding to the session for the data stream.

If the data stream is the first data stream of a new session, then session manager 212 also instantiates an OutStreams 354 data structure corresponding to the session. If the data stream is being added to an already existing session, then the previously instantiated OutStreams 354 data structure is used for the data stream. One OutStreams 354 data structure can be instantiated for each output device and/or other gateway to which data is to be streamed. As data stream 328 is received by SAS gateway 302, the S-RTP data packets are sent to the InStreams 352 data structure corresponding to the session, and then sent to the OutStreams 354 data structure corresponding to the session. From the OutStreams 354 data structure, the S-RTP data packets are streamed to the appropriate output device and/or other gateway.

The S-RTP data packets are streamed to each output device (directly or via another SAS gateway 340) that is part of the session. When an output device joins or is added to a session, the other SAS gateway from which that output device receives data streams notifies the SAS gateway 302 that S-RTP data packets for that session are to be transmitted to that other SAS gateway. The S-RTP data packets are received at that other SAS gateway, and streamed to the appropriate output devices from that other SAS gateway via another SAS interface.

Runtime components 204 are loaded by the respective function managers 312-318 (e.g., function manager 312 loads session functions 222, function manager 314 loads bundle functions 224, and so forth). Bundle manager 214 applies the specified bundle functions 224 to process the S-RTP data packets in InStreams 352 and OutStreams 354. These specified bundle functions include user-defined functions (e.g., as specified in configuration information 326) and/or system-defined functions. Stream manager 216 applies the specified stream functions 226 to process the S-RTP data packets in InStreams 352 and OutStreams 354. These specified stream functions include user-defined functions (e.g., as specified in configuration information 326) and/or system-defined functions. Resource manager 218 also applies the specified resource functions 228 to process the S-RTP data packets in InStreams 352 and OutStreams 354. These specified resource functions include user-defined functions (e.g., as specified in configuration information 326) and/or system-defined functions, such as policies for bandwidth management and/or congestion control.

It should be noted that runtime components 204 apply the specified functions to process the S-RTP data packets in InStreams 352 and OutStreams 354. Functions that are not specified do not process the S-RTP data packets in InStreams 352 and OutStreams 354. Similarly, functions that are not specified need not be, and typically are not, loaded as runtime components 204. Thus, no overhead or resources need be expended to load and/or perform functions that are not specified for a session.

In one or more embodiments, each runtime component 204 provides monitoring information to monitor 206. This monitoring information can include, for example, QoS performance, resource utilization, faults, and so forth as discussed above. The monitoring information can be provided to monitor 260 in various manners, such as using various hooks and callbacks.

In one or more embodiments, each function manager 312-318 supports user-defined functions, which are loaded and process data streams as functions 222-228. SAS gateway 302 is thus extensible, allowing various user-defined functions to be added to SAS gateway 302. New user-defined functions to be added to SAS gateway 302 are made accessible to one or more of function managers 312-318, such as by being complied separately into dynamically linked libraries that are in turn loaded and linked at runtime by the appropriate function manager 312-318.

Interaction between user-defined functions and the function managers 312-318 is also referred to as one or more system calls invoked by the user-defined functions to communicate with a function manager 312-318, and one or more up calls invoked by the function manager 312-318 to communicate with a user-defined function. The system calls provide direct access to the bundle and stream metadata, S-RTP packet information, and data of the data streams. Each user-defined function implements an object and a function manager 312-318 keeps the state information, allocates memory, and forks threads as appropriate for the object. The function managers 312-318 can also support parallel concurrent functions, allowing multiple user-defined functions to process data streams concurrently.

In one or more embodiments, user-defined functions are executed as a computing pipeline in which the user can configure the order in which the user-defined functions are applied. A user can configure the order in various manners, such as by setting a configuration option in SAS gateway 302, providing the ordering as configuration information 326 and/or 332, and so forth. The function managers 312-318 can optionally include a scheduler that is responsible for context switching to the appropriate function at the appropriate time.

The SAS kernel provides open access, as discussed above, supporting various (including non-standardized) stream formats of input and/or output devices. Using the techniques discussed herein, the SAS gateway uses the S-RTP data packets that encapsulate the frames of data, allowing the stream formats used by the various input and/or output to be separated from the SAS gateways. These techniques include end-to-end tunneling, device stream specification, semantic data propagation through S-RTP, and service negotiation.

End-to-end tunneling refers to the tunneling of data streams through the SAS kernel. The input devices and/or output devices need have no knowledge that the data streams are communicating through the SAS kernel. Although the input and/or output devices communicate with the SAS interface, the input and/or output devices need not be aware of the SAS functionality provided by the SAS interface. The SAS interface provides a publicly known interface that can be invoked by the input and/or output devices. Accordingly, typically no source code modification to the input and/or output devices need be performed.

In one or more embodiments, the SAS interface exposes a Portable Operating System Interface (POSIX) application programming interface (API) to the input and/or output devices. Each input and/or output device typically follows a client-server type of connection, providing an interface allowing the remote device to be identified. The remote device is typically identified by Internet Protocol (IP) address and port number, although other addressing techniques can alternatively be used. The input and/or output devices can, using this interface, be configured to identify the SAS interface as the remote device. The SAS interface uses socket API to intercept the frames of data from the input devices and send the frames to the output devices via the SAS gateways. Thus, a peer-to-peer virtual tunnel is created between the input device capturing data and the output device playing back the data, with the peer-to-peer virtual tunnel being supported by the SAS kernel. The SAS gateways can use any of a variety of public and/or proprietary techniques for communicating data packets between one another.

Device stream specification refers to the data packet structure for a data stream being provided to the SAS kernel. This data packet structure is provided, for example, as configuration information by the input device and/or output device, such as as part of configuration information 326, 332. The data packet structure can be identified using XML or other language or data structure. In one or more embodiments, the data packet structure includes a device specification including general metadata about the input and/or output device, and a stream specification including the data stream format. It should be noted that the data packet structure discussed herein is an example, and that other information can be included in the data packet structure in some embodiments, that some information can be removed from the data packet structure in some embodiments, and that the ordering of some information in the data packet structure can be changed in some embodiments.

The device specification includes an identifier, a content type, a content subtype, and a transport protocol. The identifier is an identifier of the device, allowing the device to be distinguished from other devices at the same location. The content type identifies the type of content in the data stream captured and/or played back by the device, such as video, audio, and so forth. The content subtype identifies the subtype of the content in the data stream captured and/or played back by the device, such as for video point cloud, mesh, and so forth. The subtype can also identify the an angle or point of view of data capture or playback. The transport protocol identifies the transport protocol used by the device, such as TCP, UDP, and so forth.

The stream specification indicates the format of the sequence of data packets as they appear in the stream from the input device (or to the output device). Data packets can be fixed-size packets or variable-size packets. For fixed-size packets, the stream specification includes the packet size (e.g., in bytes). For variable-size packets, the stream specification includes an indication of where in a fixed size header the packet size is specified. The stream specification also includes a packet count that identifies how many of each type of packets are present consecutively in the data stream.

Other data stream parameters, such as frame rate, color information, and so forth are specified through handshake packets between the end devices (between the input devices and output devices). Data packets can be marked as handshake packets, and the SAS kernel forms a multicast network between the input devices and the output devices. The SAS kernel stores and replays these handshake packets when new output devices are added to the session.

Table I illustrates an example device stream specification for a camera providing a video stream.

TABLE I

<Device Specification>

<ID>GUID</ID>
<Protocol_Type>TCP</Protocol_Type>
<Type>Video</Type>
<Subtype>Point-Cloud</Subtype>

</Device Specification
<Stream Specification>

<Packet_Fixed>

<Handshake>On</Handshake>
<Packet_Size>140</Packet_Size>
<Packet_Count>1</Packet_Count>

</Packet_Fixed>
<Packet_Variable>

<Handshake>Off</Handshake>
<Header_Size>10</Header_Size>
<Header_Offset>6</Header_Offset>
<Datasize_Type>4</Datasize_Type>
<Packet_Count>−1</Packet_Count>

</Packet_Variable>

</Stream Specification

As can be seen from the example of Table I, the identifier of the device is a globally unique identifier (GUID) referred to as GUID, the transport protocol used by the device is TCP, the type of content is video, and the subtype of content is point cloud. The data packets include a single fixed-size handshake packet of 140 bytes followed by all payload (captured data) packets of variable size that have a header of 10 bytes, with the packet size specified at byte 6 in the header. The “datasize type” field refers to the type of data used to specify the size of the payload packets, and has a value of “4” to refer to the packet size being specified using 1 32-bit integer. The packet count value of “−1” refers to a possibly infinite number of packets.

Semantic data propagation through S-RTP refers to the data packets for the data streams being encapsulated in S-RTP packets. Using S-RTP, session semantics such as device addressing, services requested, groups of streams forming bundles, and so forth are marked on each packet, allowing the state of each to be readily disseminated to various components of the SAS kernel.

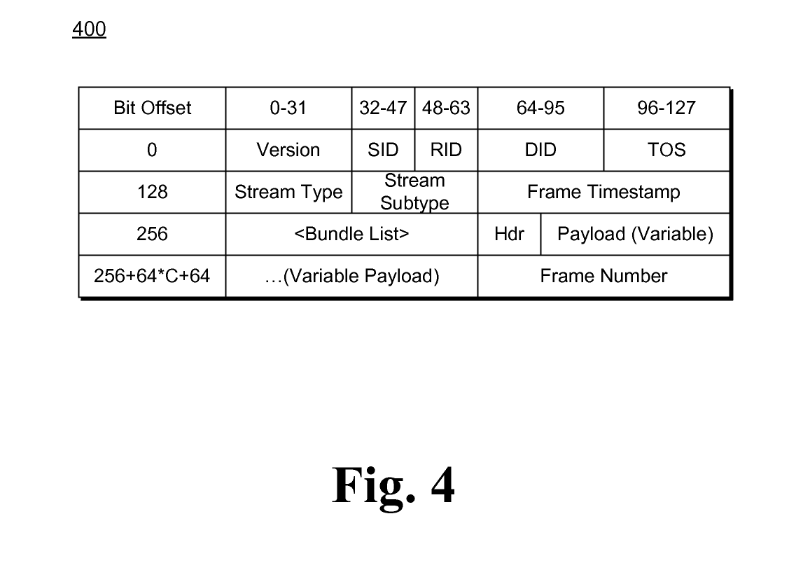

FIG. 4 illustrates an example S-RTP packet structure 400 in accordance with one or more embodiments. The S-RTP packet structure 400 includes a version portion, a session ID (SID) portion, a room or location identifier (RID) portion, a device identifier (DID) portion, a type of service (TOS) portion, a stream type portion, a stream subtype portion, a frame timestamp portion, a bundle of streams list (<Bundle List>), a header (hdr), the frames being encapsulated (payload), and a frame number. The data in the various portions of the S-RTP packet structure 400 is for the frames of a particular data stream.

The version portion (located at bits 0-31) includes data identifying the version of the S-RTP protocol being used to encapsulate the frames. The SID portion (located at bits 32-47) includes data identifying the session that the data stream is part of, the RID portion (located at bits 48-63) includes data identifying the room or location (e.g., a location 102 of FIG. 1) where the data for the data stream is captured, and the DID portion (located at bits 64-95) includes data identifying a device identifier of the input device that captures the data stream. The data in the SID, RID, and DID portions can collectively be referred to as an identifier of the data stream.

The TOS portion (located at bits 96-127) includes data that is a flag vector that specifies the requested functions (the functions requested by the input device capturing the data stream, such as those identified in configuration information provided by the input device), state information regarding functions that processed the data packet in the SAS gateway (e.g., SAS gateway 302 of FIG. 3), and a handshake bit that specifies whether the S-RTP packet is a handshake packet. The stream type portion (located at bits 128-159) includes data identifying the type (e.g., video, audio, sensory data, etc.) of the data stream, and the stream subtype portion (located at bits 160-191) includes data identifying the data format or subtype (e.g., mesh, point cloud, etc.) of the data stream.

The frame timestamp portion (located at bits 192-255) includes data identifying a date and time that the S-RTP packet is created. The bundle of streams list portion “<Bundle List>” (e.g., located at bits 256-319) includes a list of the data stream identifiers (e.g., combinations of the SID, RID, and DID for each data stream) of other data streams that are in the same bundle of streams as the data stream. Although a single 64-bit bundle of streams list portion is illustrated, alternatively S-RTP packet structure 400 can include any number of bundle of streams list portions (and thus the header portion illustrated as beginning at bit 320 would begin at bit 256+64*C, where C refers to the number of 64-bit bundle of streams list portions). The number of bundle of streams list portions is dependent on the number of streams in the same bundle of streams as the data stream, as well as the number of bits used to identify each of the streams in the same bundle of streams as the data stream (e.g., each such stream can be identified using the SID, RID, and DID of the stream, each stream can be identified using just the DID of the stream (assuming the SID and RID for the stream are the same as in bits 32-63), and so forth). For example, each stream in the same bundle of streams as the data stream can be identified as a 64-bit value (including the SID, RID, and DID of the stream), in which case C also refers to the number of other streams in the same bundle of streams as the data stream.

The header portion (e.g., located at bits 320-335) includes an indication of the size of the payload (e.g., the number of data packets in the payload portion) being transmitted. Although illustrated as beginning at bit 320, the header portion can begin at bit 256+64*C as discussed above. The payload portion (illustrated as beginning at bit 336 and continuing for any number of additional 64-bit chunks) includes frames that are the payload of the S-RTP packet. A first chunk of the payload portion may be less than 64 bits (or alternatively the header portion may be 64 bits, and the first chunk of the payload portion can also be 64 bits). Although illustrated as beginning at bit 336, the payload portion can begin at different locations depending on the size of the bundle of streams list portion. For example, the payload portion can begin at bit 256+64*C+64 (the last “+64” referring to the size of the header portion, so the payload portion can also be referred to as beginning at bit 256+64*C+X, where X refers to the size of the header portion). The payload of the S-RTP packet is the frames of the data stream that are being encapsulated. The frame number portion (located in the last 64 bits) includes data identifying the frame number of the S-RTP packet (S-RTP packets for a data stream typically being assigned sequential frame numbers as they are created).

Alternatively, the S-RTP packet structure 400 may not include the header portion and/or variable payload portion. A fixed payload portion may alternatively be used, with S-RTP packet structure 400 including a fixed number of frames that are the payload of the S-RTP packet. In such situations, the size of the payload need not be identified in S-RTP packet structure 400, and thus the header portion need not be included.

It should be noted that the packet structure 400 is an example, and that other information can be include in the packet structure 400 in some embodiments, and that some information can be removed from the packet structure 400 in some embodiments. Additionally, the ordering of information in the packet structure 400 can be changed (e.g., the SID and RID can be located at bits 0-31 rather than 32-63), the number of bits allocated for each portion of packet structure 400 can be changed (e.g., 16 bits can be used to identify the version rather than 32 bits), and so forth.

Service negotiation refers to session initiation and service negotiation for streaming of data streams. After reading the configuration information indicating a stream specification for the data stream and generating an S-RTP packet, the SAS interface initiates a session with the SAS gateway as discussed above. Various remote procedure calls (RPCs), marshaling, and session initiation and negotiation protocols can be used between the SAS interface and the SAS gateway.

In one or more embodiments, when a new data stream captured by an input device is to be added to a session, the SAS interface sends a “join” request message to the SAS gateway. The “join” message request indicates the desired transport protocol for the data stream, the characteristics of the data stream being added and of the bundle of streams to which the data stream is being added, and the services requested. These characteristics of the data stream and the bundle of streams include, for example, whether the bundle and data stream are periodic or aperiodic, whether the bundle and data stream used variable or fixed packet sizes, the payload types of the bundle and data stream, the payload subtypes of the bundle and data stream, the expected bandwidth usage of the bundle and data stream, and so forth. The services requested can include, for example, encryption, compression, congestion control, and so forth.

In response to receiving the “join” message request, the SAS gateway determines whether it can support the requested services, and if so opens the appropriate data ports and returns an indication of acceptance of the request as discussed above. If one or more requested services are not supported by the SAS gateway, then the adding of the data stream can be renegotiated. For example, the input device desiring to add a data stream to the session can be informed that the desired type of encryption is not supported by the SAS gateway, and can again attempt to join the session requesting as a service another type of encryption.

In one or more embodiments, when a new output device is to be added to a session to receive a data stream, the SAS interface similarly sends a “join” request message to the SAS gateway. The “join” message request indicates the payload type and subtype supported by the output device, indicating the type of data stream the output device is to receive. The SAS kernel uses the payload type and subtype to determine which bundles of streams and/or data streams are to be routed to the output device by matching the payload type and the subtype of the InStreams with the payload type and subtype specified in the request. For example, two different renderers (e.g., display devices, windows of a display device, etc.) may be used at a location, one to display the frontal camera data stream and the other to display the back camera data stream. Both renderers specify the “video” type, one renderer and the frontal camera use a “frontal” subtype, and the other renderer and the back camera us a “back” subtype. Thus, the appropriate data steam to be provided to the added output device can be readily determined.

Given the configuration information, system-defined functions, and user-defined functions, the SAS kernels can readily provide correlated multi-streaming. The SAS kernels have knowledge of which streams are included in a bundle of streams, and can coordinate transmitting of data to the other SAS kernels in a session to maintain synchronization and correlation of the streams in a bundle. For example, the SAS kernels can transmit S-RTP packets to other SAS kernels in order of the frame timestamps, subject to possibly dropping at least some S-RTP packets for one or more lower priority streams in a session as discussed above.

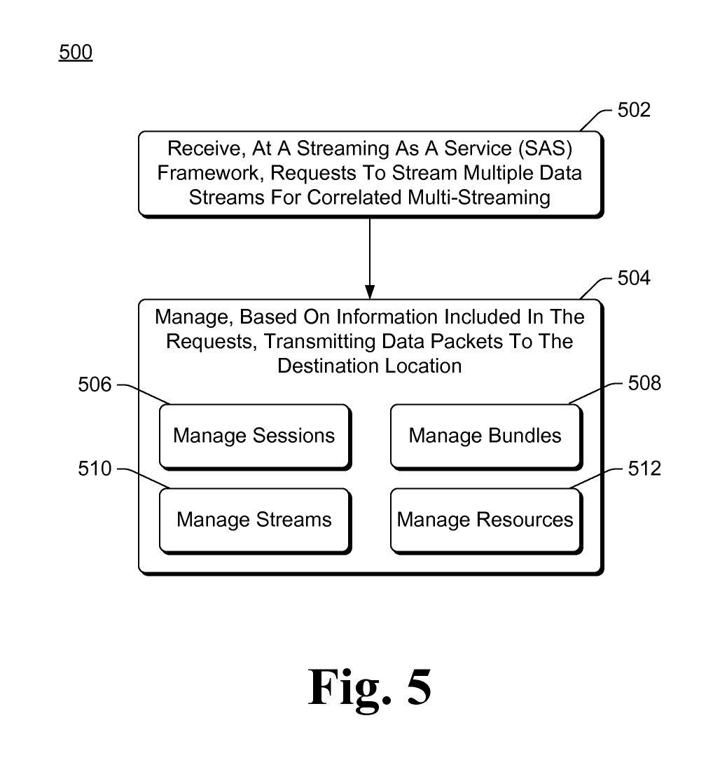

FIG. 5 is a flowchart illustrating an example process 500 for implementing the streaming service for correlated multi-streaming in accordance with one or more embodiments. Process 500 can be implemented in software, firmware, hardware, or combinations thereof. Process 500 is carried out by, for example, one or more SAS kernels 108 of FIG. 1, SAS kernel framework 200 of FIG. 2, or a system 300 of FIG. 3. Process 500 is shown as a set of acts and is not limited to the order shown for performing the operations of the various acts. Process 500 is an example process for implementing the streaming service for correlated multi-streaming; additional discussions of implementing the streaming service for correlated multi-streaming are included herein with reference to different figures.

In process 500, requests to stream multiple data streams for correlated multi-streaming are received at an SAS framework (act 502). These requests include requests to add or join data streams to a session, as discussed above. These requests also include configuration information, as discussed above.

Based on the information included in the requests, transmitting of data packets to one or more destination locations is managed (act 504). The data packets are transmitted as S-RTP data packets, as discussed above.

The managing in act 504 can include managing sessions (act 506), such as by session functions 222 discussed above. The managing in act 504 can also include managing bundles of streams (act 508), such as by bundle functions 224 discussed above. The managing in act 504 can also include managing individual streams (act 510), such as by stream functions 226 discussed above. The managing in act 504 can also include managing resources (act 512), such as by resource functions 228 discussed above.

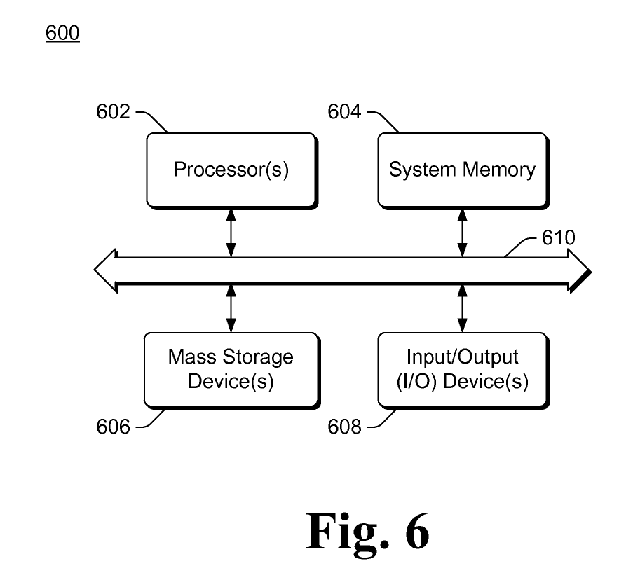

FIG. 6 is a block diagram illustrating an example computing device 600 in which the streaming service for correlated multi-streaming can be implemented in accordance with one or more embodiments. One or more computing devices 600 can be used to implement the various techniques and processes discussed herein. Computing device 600 can be any of a wide variety of computing devices, such as a desktop computer, a server computer, a handheld computer, a laptop or netbook computer, a tablet or notepad computer, a personal digital assistant (PDA), an internet appliance, a game console, a set-top box, a cellular or other wireless phone, a network gateway or router, and so forth.

Computing device 600 includes one or more processor(s) 602, computer readable storage media such as system memory 604 and mass storage device(s) 606, input/output (I/O) device(s) 608, and bus 610. One or more processors 602, at least part of system memory 604, one or more mass storage devices 606, one or more of devices 608, and/or bus 610 can optionally be implemented as a single component or chip (e.g., a system on a chip).

Processor(s) 602 include one or more processors or controllers that execute instructions stored on computer readable storage media. The computer readable storage media can be, for example, system memory 604 and/or mass storage device(s) 606. Processor(s) 602 may also include computer readable storage media, such as cache memory. The computer readable storage media refers to media for storage of information in contrast to mere signal transmission, carrier waves, or signals per se. However, it should be noted that instructions can also be communicated via various computer readable signal bearing media rather than and/or in addition to computer readable storage media.

System memory 604 includes various computer readable storage media, including volatile memory (such as random access memory (RAM)) and/or nonvolatile memory (such as read only memory (ROM)). System memory 604 may include rewritable ROM, such as Flash memory.

Mass storage device(s) 606 include various computer readable storage media, such as magnetic disks, optical discs, solid state memory (e.g., Flash memory), and so forth. Various drives may also be included in mass storage device(s) 606 to enable reading from and/or writing to the various computer readable storage media. Mass storage device(s) 606 include removable media and/or nonremovable media.

I/O device(s) 608 include various devices that allow data and/or other information to be input to and/or output from computing device 600. Examples of I/O device(s) 608 include cursor control devices, keypads, microphones, monitors or other displays, speakers, printers, network interface cards, modems, lenses, CCDs or other image capture devices, and so forth.

Bus 610 allows processor(s) 602, system 604, mass storage device(s) 606, and I/O device(s) 608 to communicate with one another. Bus 610 can be one or more of multiple types of buses, such as a system bus, PCI bus, IEEE 1394 bus, USB bus, and so forth.

Generally, any of the functions or techniques described herein can be implemented using software, firmware, hardware (e.g., fixed logic circuitry), manual processing, or a combination of these implementations. The terms “module” and “component” as used herein generally represent software, firmware, hardware, or combinations thereof. In the case of a software implementation, the module or component represents program code that performs specified tasks when executed on a processor (e.g., CPU or CPUs). The program code can be stored in, for example, one or more computer readable storage media, further description of which may be found with reference to FIG. 6. In the case of hardware implementation, the module or component represents a functional block or other hardware that performs specified tasks. For example, in a hardware implementation the module or component can be an application-specific integrated circuit (ASIC), field-programmable gate array (FPGA), complex programmable logic device (CPLD), and so forth. The features of the streaming service for correlated multi-streaming described herein are platform-independent, meaning that the techniques can be implemented on a variety of commercial computing platforms having a variety of processors.

Although the description above uses language that is specific to structural features and/or methodological acts in processes, it is to be understood that the subject matter defined in the appended claims is not limited to the specific features or processes described. Rather, the specific features and processes are disclosed as example forms of implementing the claims. Various modifications, changes, and variations apparent to those skilled in the art may be made in the arrangement, operation, and details of the disclosed embodiments herein.

What is claimed is:

1. A method implemented in a streaming as a service (SAS) framework, the method comprising:
receiving, at a source location, requests to stream multiple data streams for correlated multi-streaming from the source location to a destination location, the multiple data streams being received from multiple different types of input devices at the source location; and
managing, based on information included in the requests, transmitting data packets of the multiple data streams to the destination location, the managing including processing the data of at least one of the multiple data streams by a user-defined function.

2. A method as recited in claim 1, the multiple data streams being included as part of a session, and the managing further including performing session management for the multiple data streams.

3. A method as recited in claim 1, the multiple data streams including multiple bundles of streams, and the managing further including processing each of the multiple data streams based at least in part on in which of the multiple bundles the data stream is included.

4. A method as recited in claim 1, the managing further including processing the multiple streams using stream-based runtime functions.

5. A method as recited in claim 1, the managing being performed in an SAS kernel, and the managing further including receiving the multiple data streams via an SAS interface from input devices having no knowledge of the SAS kernel.

6. A method as recited in claim 1, the information included in a request from an input device comprising configuration information that includes metadata regarding the input device and a specification of a format of a data stream provided by the input device.

7. A method as recited in claim 1, the managing being performed in an SAS kernel, and each of the multiple data streams including multiple frames, the multiple frames being encapsulated in an SAS Real-Time Protocol data packet prior to being provided to the SAS kernel.

8. A method as recited in claim 1, the managing including processing the data of the at least one of the multiple data streams by a system-defined function.

9. A method as recited in claim 1, the managing including transmitting data packets of the multiple data streams to the destination location based at least in part on quality of service metrics defined based on the multiple data streams.

10. One or more computer readable storage media having stored thereon multiple instructions that implement a streaming as a service (SAS) framework and that, when executed by one or more processors of one or more devices, cause the one or more processors to perform acts comprising:
receiving, at a source location, requests to stream multiple data streams for correlated multi-streaming from the source location to a destination location, the multiple data streams being received from multiple different types of input devices at the source location; and
managing, based on information included in the requests, transmitting data packets of the multiple data streams to the destination location, the managing including processing the data of at least one of the multiple data streams by a user-defined function.

11. One or more computer readable storage media as recited in claim 10, the managing further including performing one or more operations over a session including the multiple data streams.

12. One or more computer readable storage media as recited in claim 10, the multiple data streams including multiple bundles of streams, and the managing further including performing one or more operations over individual bundles of the multiple bundles.

13. One or more computer readable storage media as recited in claim 10, the managing further including performing one or more operations over individual streams of the multiple data streams.

14. One or more computer readable storage media as recited in claim 10, the managing being performed in an SAS kernel, and the managing further including receiving the multiple data streams via an SAS interface from input devices having no knowledge of the SAS kernel.

15. One or more computer readable storage media as recited in claim 10, the information included in a request from an input device comprising configuration information that includes metadata regarding the input device and a specification of a format of a data stream provided by the input device.

16. One or more computer readable storage media as recited in claim 10, the managing being performed in an SAS kernel, and each of the multiple data streams including multiple frames, the multiple frames being encapsulated in an SAS Real-Time Protocol data packet prior to being provided to the SAS kernel.

17. One or more computer readable storage media as recited in claim 10, the managing including processing the data of the at least one of the multiple data streams by a system-defined function.

18. One or more computer readable storage media as recited in claim 10, the managing including transmitting data packets of the multiple data streams to the destination location based at least in part on quality of service metrics defined based on the multiple data streams.

19. A streaming service implemented at least in part in hardware, the streaming service comprising:
a streaming as a service (SAS) interface accessible to multiple input devices and multiple output devices at a first location, the SAS interface operating to encapsulate frames of data streams received from the multiple input devices in streaming packets prior to providing the streaming packets to an SAS gateway, and to extract frames of data streams received from the SAS gateway prior to providing the frames to the multiple output devices; and
the SAS gateway operating to manage communicating streaming packets with one or more other SAS gateways, wherein to manage communicating the streaming packets is to manage communicating the streaming packets based at least in part on quality of service metrics defined based on multiple ones of the data streams.

20. A streaming service as recited in claim 19, the data streams being included as part of a session, and wherein to manage communicating the streaming packets is further to perform session management for the data streams.

21. A streaming service as recited in claim 19, the data streams including multiple bundles of streams, and wherein to manage communicating the streaming packets is further to process each of the data streams based at least in part on in which of the multiple bundles the data stream is included.

22. A streaming service as recited in claim 19, wherein to manage communicating the streaming packets is further to process the streaming packets using stream-based runtime functions.

23. A streaming service as recited in claim 19, the multiple input devices and multiple output devices having no knowledge of the SAS gateway.

24. A streaming service as recited in claim 19, the SAS interface further operating to receive, from each of the multiple input devices, configuration information that includes metadata regarding the input device and a specification of a format of a data stream provided by the input device.

25. A streaming service as recited in claim 19, wherein to manage communicating the streaming packets is further to process the streaming data packets using one or more system-defined functions and one or more user-defined functions.
